(19) United States
(12) Patent Application Publication
(10) Pub. No.: US 2014/0089095 A1
(43) Pub. Date: Mar. 27, 2014

(54) Wireless Power Transfer (WPT) With Integrated Advertising Channel

(71) Applicant: James BENNETT, Hroznetin (CZ)

(72) Inventor: James BENNETT, Hroznetin (CZ)

(21) Appl. No.: 13/629,073

(22) Filed: Sep. 27, 2012

(51) Int. Cl. G06Q 30/02

(52) U.S. Cl. CPC G06Q 30/0267
USPC 705/14.64

(57) ABSTRACT

A system includes an access point (AP)/charging station, a client device, a local business advertising content/query system, a remote Authentication, Authorization, and Accounting (AAA) processing and billing management service, an advertising content/query service, and an alternate AP. The station provides compensation to the client device in exchange for the client device consuming advertising content. The advertising content may include one or more of a product advertisement, a service advertisement, and a survey. The compensation may include one or more of Internet access, charging power, a product discount, and a service discount.

### BACKGROUND

1. Field of the Invention

The field of the invention relates generally to advertising.

2. Background Art

In a variety of scenarios, a mobile client device is either not mobile or within a short distance relative to a service station from which the client device receives a service. For example, a portable device connected to a charging station is in a relatively fixed position relative to the charging station for the duration of the charging session. Such scenarios are well suited to provide tailored advertising to the user of the client device.

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the subject matter of the disclosure.

FIG. 1 illustrates an example system according to an embodiment of the present disclosure.

FIG. 2 illustrates an example access point (AP)/charging station according to an embodiment of the present disclosure.

FIG. 3 illustrates an example client device according to an embodiment of the present disclosure.

FIG. 4 is a process flowchart of a method according to an embodiment of the present disclosure.

FIG. 5 illustrates another example system according to an embodiment of the present disclosure.

FIG. 6 is a process flowchart of a method according to an embodiment of the present disclosure.

The present disclosure will be described with reference to the accompanying drawings. Generally, the drawing in which an element first appears is typically indicated by the leftmost digit(s) in the corresponding reference number.

### DETAILED DESCRIPTION OF EMBODIMENTS

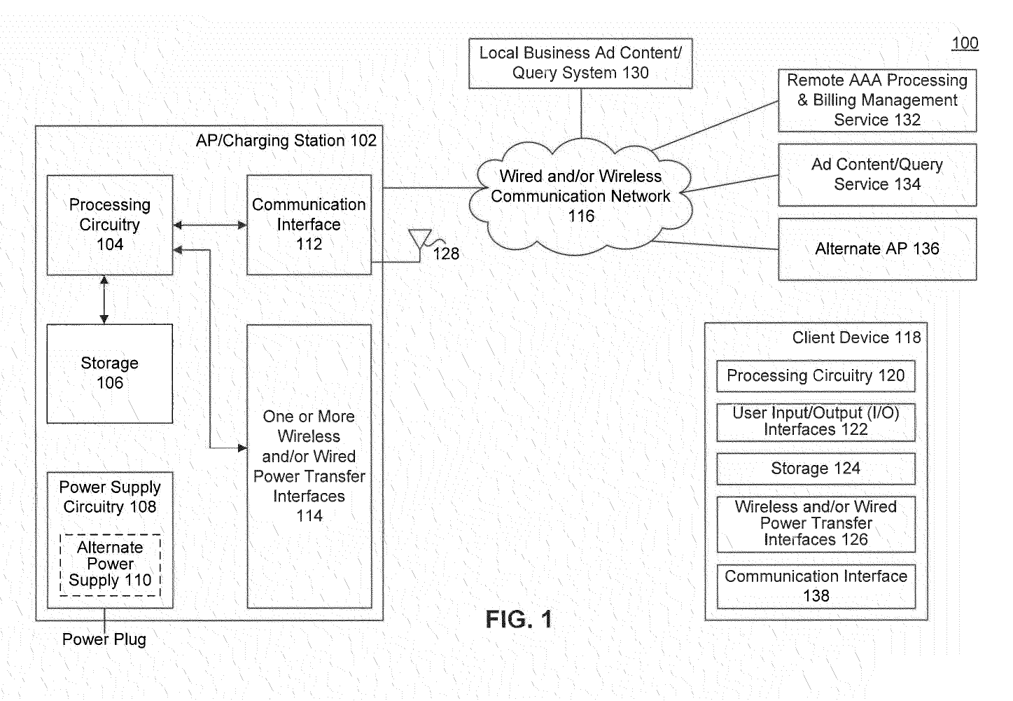

FIG. 1 illustrates an example system 100 according to an embodiment of the present disclosure. Example system 100 is provided for the purpose of illustration and is not limiting of embodiments of the present disclosure. As can be appreciated by a person of skill in the art based on the teachings herein, embodiments of the present disclosure may be used to enable different systems than shown in FIG. 1.

As shown in FIG. 1, example system 100 includes an access point (AP)/charging station 102, a client device 118, a local business advertising content/query system 130, a remote Authentication, Authorization, and Accounting (AAA) processing and billing management service 132, an advertising content/query service 134, and an alternate AP 136. As would be understood by a person of skill in the art, in other embodiments, example system 100 may include other systems and/or services. For example, example system 100 may include more than one system 130 each associated with a respective local business, more than one service 134 provided by various advertisement providers, and multiple client devices 118.

A wired and/or wireless communication network 116 (e.g., the Internet, a cellular network, etc.) connects the various components of example system 100. For example, as shown in FIG. 1, AP/charging station 102, system 130, service 132, service 134, and alternate AP 136 each has a wired connection to network 116. In other embodiments, at least one of AP/charging station 102, system 130, service 132, service 134, and alternate AP 136 may, additionally or alternatively, wirelessly connect to network 116. Client device 118 may connect to network 116 through wired or wireless means, with the wired/wireless connection being a direct connection or via AP/charging station 102 as further described below.

The various components of example system 100 may be located in various geographical locations, which may be near or remote from each other. For example, in an embodiment, AP/charging station 102, client device 118, and system 130 may be located within the same geographical environment (e.g., airport, shopping mall, business store, restaurant, coffee shop, etc.). In another embodiment, client device 118 may be in the vicinity of AP/charging station 102, but the rest of the components of system 100 may be remotely located.

Station 102 may be located in a public or a private place. For example, without limitation, station 102 may be located in an airport, shopping mall, restaurant, coffee shop, bookstore, hospital, airplane, train, bus, etc. In an embodiment, as shown in FIG. 1, station 102 includes processing circuitry 104, a storage 106, power supply circuitry 108, including an alternate power supply 110 (e.g., battery), a communication interface 112, one or more wireless and/or wired power transfer interfaces 114, and an antenna 128.

Processing circuitry 104 enables AP/charging station 102 to provide one or more services such as Internet access and/or wired/wireless power charging to client devices, such as client device 118, for example. In an embodiment, station 102 provides the one or more services to client device 118 free of charge. In other embodiments, station 102 provides the one or more services and/or a reward (e.g., product discount, service discount, coupon, gift certificate, rebate, etc.) (hereinafter collectively referred to as compensation) to client device 118 in exchange for client device 118 consuming advertising content.

As used herein, advertising content refers to any type of content (e.g., text, audio, video, animation, etc.) intended to drive consumer behavior and/or encourage or persuade an audience to take some action. For example, the advertising content may include one or more of a product advertisement, a service advertisement, a consumer survey, etc. As further described herein, the advertising content may be locally stored within station 102, delivered by a system associated with a local business (e.g., business located near station 102), or delivered by a remote advertising service (e.g., in response to an Internet search command, through a single/multi-vendor advertising/couponing application, through a business website, etc.). Consuming advertising content includes one or more of viewing the advertising content on a display, interacting with the advertising content via a user interface, redeeming the advertising content with a vendor, and purchasing a product or service associated with the advertising content.

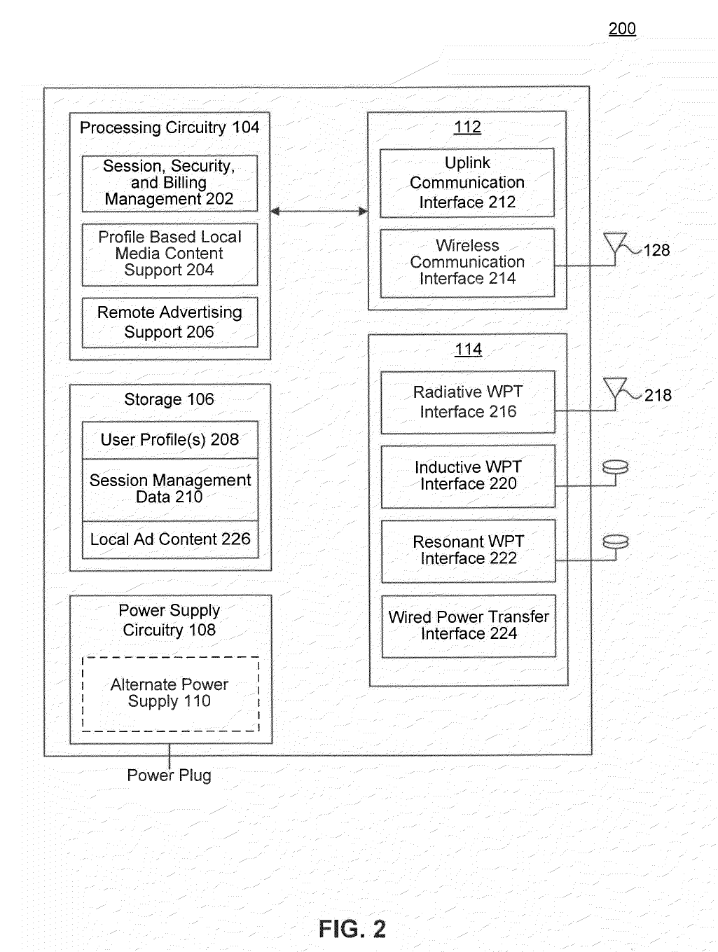

To support the above described functionality, in an embodiment (e.g., example AP/charging station 200 shown in FIG. 2), processing circuitry 104 implements a session, security, and billing management module 202, a profile based local media content support module 204, and a remote advertising support module 206. Modules 202, 204, and 206 may be implemented using hardware, software, and/or firmware. Further description of modules 202, 204, and 206 is provided below with reference to the example use scenarios of system 100.

For purposes of this discussion, the term “module” shall be understood to include at least one of software, firmware, and hardware (such as one or more circuits, microchips, or devices, or any combination thereof), and any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

Storage 106 may include various forms of memory to support the functionality of processing circuitry 104. For example, storage 106 may include a Random Access Memory (RAM), a non-volatile RAM (NVRAM), and a Read-Only Memory (ROM). In an embodiment, the RAM is used by processing circuitry 104 in support of its processing functions. The ROM is used to store software and or firmware associated with modules 202, 204, and 206. The NVRAM is used to store data generated by processing circuitry 104 in the course of servicing client devices and/or locally stored advertising content. For example, in an embodiment (e.g., example AP/charging station 200 shown in FIG. 2), storage 106 includes areas for storing user profile(s) 208, session management data 210, and locally stored advertising content 226.

Power supply circuitry 108 provides power to the various components of AP/charging station 102 and enables AP/charging station 102 to provide wireless/wired power charging to client devices, such as client device 118. Power supply circuitry 108 receives power from a power plug (e.g. AC power plug). Optionally, power supply circuitry 108 includes an alternate power supply 110, which may include a battery and/or other forms of energy storage and delivery.

Communication interface 112 includes various wired and/or wireless interfaces that enable AP/charging station 102 to be connected to wired and/or wireless communication network 116 and to communicate with client devices, such as client device 118. In an embodiment (e.g., example AP/charging station 200 shown in FIG. 2), communication interface 112 includes an uplink communication interface 212 and a wireless communication interface 214. Uplink communication interface 212 may be wired and/or wireless and connects AP/charging station 102 to communication network 116. Wireless communication interface 214 allows AP/charging station 102 to communicate via a wireless antenna 128 with client devices, such as client device 118. For example, without limitation, wireless communication interface 214 may include a WiFi, Bluetooth, RFID (Radio Frequency Identification), and/or a NFC (near-field communication) interface. In other embodiments, communication interface 112 includes a wired interface (e.g., Universal Serial Bus) that can he used for communication with client devices.

Power transfer interfaces 114 include one or more wireless and/or wired power transfer interfaces. Power transfer interfaces 114 enable AP/charging station 102 to power charge client devices, such as client device 118. In an embodiment (e.g., example AP/charging station 200 shown in FIG. 2), power transfer interfaces 114 include a radiative wireless power transfer (WPT) interface 216 that provides radiative wireless power via an antenna 218, an inductive WPT interface 220, a resonant WPT interface 222, and a wired power transfer interface 224. By supporting power transfer interfaces of various types, AP/charging station 102 can charge a variety of client devices with different power transfer interfaces. Additionally, each wired/wireless interface of AP/charging station 102 may simultaneously charge one or more client devices, thereby allowing AP/charging station 102 to be a multi-client charging station.

Client device 118 may be any device that may benefit from embodiments of the present disclosure. For example, without limitation, client device 118 may be a laptop computer, a smart phone, a headset, a digital camera, a gaming device, a music player, a hybrid/electric car, etc. For the purpose of illustration only, client device 118 is assumed to be a smart phone in the below described example use scenarios of example system 100. However, as would be understood by a person of skill in the art based on the teachings herein, client device 118 need not be a smart phone in the example use scenarios.

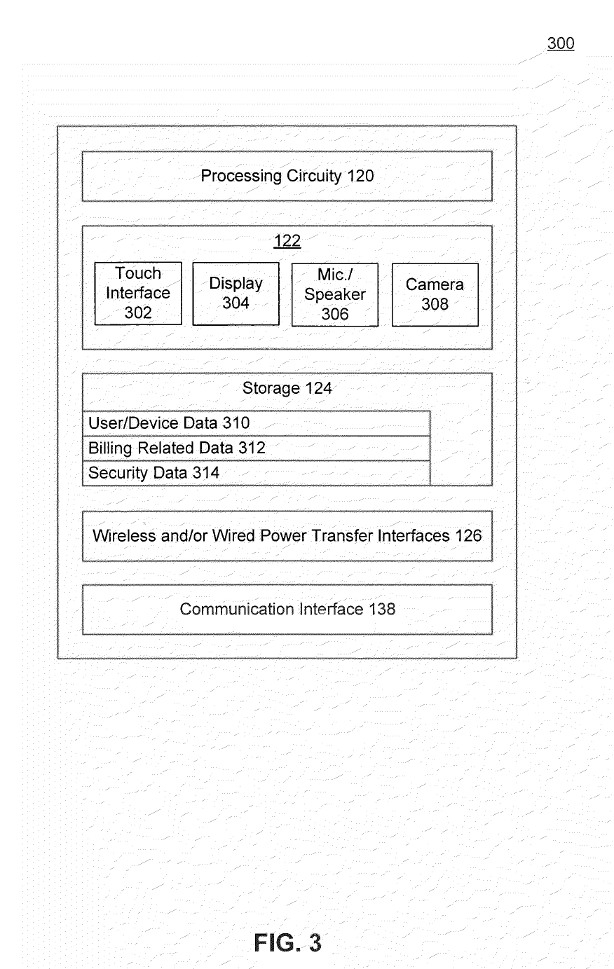

In an embodiment (e.g., as shown in FIG, 1), client device 118 includes processing circuitry 120, user input/output (I/O) interfaces 122, storage 124, wireless and/or wired power transfer interfaces 126, and a communication interface 138. Process circuitry 120 may be any type of processor capable of performing the data processing and communication functions described herein of client device 118. User I/O interfaces 122 may include (e.g., as shown in example client device 300 shown in FIG. 3) a touch interface 302 (e.g., keyboard, touch screen, etc.), a display 304, a microphone/speaker 306, and a camera 308.

Storage 124 may include various forms of memory to support the functionality of processing circuitry 120. For example, storage 124 may include a Random Access Memory (RAM), a non-volatile RAM (NVRAM), and a Read-Only Memory (ROM). Specifically, in an embodiment (e.g., example client device 300 shown in FIG. 3), storage 124 includes areas for storing user/device data 310, billing related data 312, and security data 314. Further description of user/device data 310, billing related data 312, and security data 314 is provided below with reference to the example use scenarios of system 100.

Wireless and/or wired power transfer interfaces 126 enable client device 118 to receive charging power from external sources, such as AP/charging station 102. In embodiments, power transfer interfaces 116 may include a radiative WPT interface, an inductive WPT interface, a resonant WPT interface, and/or a wired power transfer interface.

Communication interface 138 may include one or more wired and/or wireless interfaces that enable client device 118 to connect to network 116 and/or to AP/charging station 102. In an embodiment, communication interface 138 includes a wired/wireless communication interface that enables client device 118 to communicate with AP/charging station 102. For example, without limitation, the wireless communication interface may include an Ethernet, WiFi, Bluetooth, RFID, and/or a NFC interface. The same or a different wired/wireless communication interface may enable client device 118 to connect to network 116.

System 130 includes a local business advertising content/query system. System 130 may be located within the same geographical environment (e.g., airport, shopping mall, business store, restaurant, coffee shop, etc.) as AP/charging station 102. For example, system 130 may be a server located in a local business located in the same environment as AP/charging station 102. Alternatively, system 130 may be a remote server tailored to provide advertising content/queries relevant to a local business located in the same geographical environment as AP/charging station 102. In embodiments, system 130 may provide advertising content/queries to AP/charging station 102, client device 118 (either directly or via AP/charging station 102), and/or to service 134. As used herein, a query includes any type of content intended to gauge consumer interest, including a survey, questionnaire, etc.

Service 134 is provided by one or more remote advertising servers. Service 134 may be tailored based on (e.g., profile) information associated with AP/charging station 102 and/or client device 118. For example, service 134 may be provided in response to an Internet search command by client device 118, whereby the search terms are used to tailor the advertising content/query provided by service 134. Alternatively or additionally, service 134 may be provided by a single/multi-vendor advertising/couponing system with a corresponding application that executes on client device 118 and/or AP/charging station 102. Alternatively or additionally, service 134 may be provided by a website associated with a business or retailer.

Service 132 is provided by a remote AAA processing and billing management server. As further described below, service 132 may be used to complete a payment transaction between client device 118 and AP/charging station 102. Additionally, service 132 may provide billing management for AP/charging station 102 in order to collect a payment from system 130 and/or service 134 in return for delivering advertising content to client device 118.

Alternate AP 136 may be similar to AP/charging station 102. For example, AP 136 may provide Internet access and/or wireless/wired power charging. As such, AP 136 may include similar components and perform similar functions as described herein with reference to AP/charge station 102. AP 136 may be owned and/or operated by the same or different entity as AP/charging station 102. In an embodiment, AP 136 may be located within the same geographical environment as AP/charging station 102. For example, AP/charging station 102 may be located in a public area of an airport/shopping mall, and AP 136 may be located inside a retailer store at the same airport/shopping mall. In another embodiment, AP 136 may be located in a remote location relative to AP/charging station 102.

Example use scenarios of example system 100 will now be described. In these example use scenarios, it is assumed that AP/charging station 102 implements example AP/charging station embodiment 200 shown in FIG. 2 and that client device 118 implements example client device embodiment 300 shown in FIG. 3. These examples are provided for the purpose of illustration only and are not limiting of embodiments of the present disclosure.

The example use scenarios begin with client device 118 being brought in a vicinity of AP/charging station 102. For example, client device 118 may be placed on top of AP/charging station 102, docked into AP/charging station 102, plugged via a wire into AP/charging station 102, or moved within a certain distance from AP/charging station 102.

Upon bringing client device 118 in the vicinity of AP/charging station 102, a communication link is established between communication interface 112 of AP/charging station 102 and communication interface 138 of client device 118. For example, without limitation, the communication link may be established using USB, WiFi, Bluetooth, RFID, or NFC. The communication link may be established automatically upon AP/charging station 102 detecting the presence of client device 118 or by client device 118 sending a signal to AP/charging station 102 (e.g., a broadcast signal) using an application executing on client device 118.

Using the established communication link, AP/charging station 102 sends an offer to consume advertising content to client device 118. In an embodiment, the offer is generated by module 202 of AP/charging station 102, which is responsible for session management. At client device 118, the offer is displayed on display 304 as a popup or using other forms of message delivery. The offer may spell out the terms and conditions associated with the offer and/or with accepting the offer. In an embodiment, the offer includes the types of compensation provided by AP/charging station 102 (e.g., Internet access, power charging, product/service discount, coupon, gift certificate, rebate, etc.) and the forms of recompense accepted by AP/charging station 102 in return for the compensation. For example, AP/charging station 102 may provide the compensation in return for payment by the user and/or the user accepting to consume advertising content on client device 118. Consuming advertising content includes one or more of viewing the advertising content on a display, interacting with the advertising content via a user interface, redeeming the advertising content (e.g., coupon) with a vendor, and purchasing a product or service associated with the advertising content. Alternatively, AP/charging station 102 may provide the compensation free of charge to the user, and then may bill a third-party sponsor, for example, for a portion of the compensation cost.

A user of client device 118 may accept or reject the offer using touch interface 302 of client device 118. In an embodiment, the user may select the desired compensation, a duration of the desired compensation (when applicable), and a form of recompense in return for the compensation, before sending an acceptance of the offer to AP/charging station 102.

Depending on the selected compensation and/or the form of recompense, the user may be asked to provide additional information (e.g., user/device data, billing related data, preferences, etc.) as part of the acceptance of the offer. For example, the user may choose to receive wireless charging power from AP/charging station 102 in return for payment, the purchase of an advertised product/service, or the redemption of advertising content (e.g., coupon). As such, the user may be asked to input billing related information, such as credit card information, account information, coupon information, etc. Such information may be part of billing related data 312 stored in storage 124 of client device 118. In another example, the user may choose to receive a product/service discount in return for viewing advertising content on client device 118. As such, the user may be asked to input or select a user profile (e.g., gender, age, education level, etc.), a device profile (device model, operating system, IP address, etc.), advertisement type preference (e.g., audio, video, still image, etc.), and/or to select from multiple available advertisement sessions (e.g., based on product/service type, vendor, duration, etc.). Such information may be part of user/device data 310 stored in storage 124 of client device 118. Alternatively, or additionally, the information is automatically extracted front client device 118 and included in the acceptance without user input. For example, data for device and/or user authentication may be automatically extracted from security data 314 stored in storage 124 and included in the acceptance. AP/charging station 102 may use this authentication data to authenticate the device and/or user before delivering the compensation.

As mentioned above, in some embodiments, the recompense offered by the user in return for the compensation delivered by AP/charging station 102 may include a payment by the user. In an embodiment, payment processing is done by service 132 with AP/charging station 102 acting as an intermediary between client device 118 and service 132. For example, AP/charging station 102 may receive, via module 202, the billing related information from client device 118 and then relay the information to service 132. Conversely, AP/charging station 102 may receive, via module 202, a transaction result (e.g., successful payment confirmation, unsuccessful payment message, etc.) front service 132 and then relay the transaction result to client device 118. In the case that payment is associated with a product/service purchase or redemption of advertising content, AP/charging station 102 may also send the transaction result to the product/service seller in order to provide the product/service to client device 118. In another embodiment, payment processing is done directly between client device 118 and service 132. For example, upon selecting the payment option and accepting the offer, a payment form is launched on client device 118 allowing the user to complete payment processing by sending billing related information directly to service 132 and receiving the transaction result directly from service 132. In this embodiment, service 132 may then contact AP/charging station 102 with the transaction result so that AP/charging station may determine whether (and for how long) or not to provide the compensation to client device 118, or may send the transaction result to the product/service seller (when applicable) in order to provide the product/service to client device 118. Alternatively, client device 118 may be equipped with a billing application that enables automatic payment with access to billing information saved on the device.

Once the user of client device 118 is done configuring the acceptance to the offer, the user may send the acceptance to AP/charging station 102 using the established communication link. In case the user selects to pay for or to purchase a product/service in return for the compensation provided by AP/charging station 102, the acceptance takes the form of a successful payment confirmation received from service 132. If the user rejects the offer or closes the offer, then no further interaction between client device 118 and AP/charging station 102 takes place.

Once AP/charging station 102 receives the acceptance from client device 102 (or from service 132), AP/charging station 102 may extract certain information from the acceptance and then initiate delivery of the compensation. In an embodiment, AP/charging station 102, via module 202, extracts a user and/or device profile, an advertisement type preference, and/or an advertisement session selection from the acceptance and stores the information in the area of storage 106 assigned for storing user profile(s) 208. Additionally, AP/charging station 102, via module 202, may extract or generate session related data (e.g., compensation credit/duration, compensation rate, etc.) from the acceptance and store the data in the area of storage 106 assigned for storing session management data 210.

Depending on the form of recompense selected by the user of client device 118 in return for the compensation, AP/charging station 102 may share the extracted information with other components of example system 100. For example, AP/charging station 102 may share, via module 206, the extracted information with service 134 in order to tailor its content accordingly.

Delivery of the compensation, according to embodiments, may vary depending on the form of recompense selected by the user of client device 118 in return for the compensation. For example, in the case the user pays for or purchases a product/service in return for the compensation, then AP/charging station 102 begins delivery of the compensation immediately upon receiving confirmation of successful payment and terminates delivery of the compensation at a time determined by the offer. However, when the recompense selected by the user of client device 118 includes consuming advertising content, then AP/charging station 102 begins delivery of the compensation upon receiving a confirmation signal that client device 118 has begun consuming the advertising content as agreed upon. As further described below, this confirmation signal may come from client device 118 or from another system that delivers the advertising content to client device 118. Further, the confirmation signal may be provided such that AP/charging station 102 knows when client device 118 stops consuming advertising content so that AP/charging station 102 can stop delivering the compensation.

According to embodiments, the advertising content may originate from AP/charging station 102 and/or from another system (e.g., system 130, service 134, etc.), and may be delivered to client device 118 from AP/charging station 102 over the established communication link and/or from another system (e.g., system 130, service 134, etc.) via a separate link. For example, the advertising content may be generated from locally stored advertising content 226 stored in storage 106 of AP/charging station 102 and then delivered to client device 118 over the established communication link. In an embodiment, the advertising content is retrieved by module 204 from storage 106 based on the user and/or device profile associated with client device 118, stored in user profile(s) 208.

Alternatively, or additionally, the advertising content may originate from another system (e.g., system 130, service 134, etc.) and is received by AP/charging station 102, via module 206, over communication network 116. AP/charging station 102, via module 206, may then tailor the content based on the user and/or device profile associated with client device 118 before sending the advertising content to client device 118. Alternatively, or additionally, AP/charging station 102, via module 206, may share information extracted from the acceptance (e.g., user and/or device profile) with another system (e.g., system 130, service 134, etc.), which may then tailor its content according to the shared information. The other system may then send the tailored content to AP/charging station 102 for delivery to client device 118 and/or directly to client device 118 via a separate link. In the case that content is delivered directly to client device 118, AP/charging station 102, via module 206, shares the IP address of client device 118 with the other system.

As mentioned above, in an embodiment, AP/charging station 102 receives a confirmation signal indicating that client device 118 has begun consuming the advertising content. The compensation is then delivered to client device 118. The confirmation signal may be received directly from client device 118. For example, the advertising content may be displayed on client device 118 using an application that executes on client device 1.18. Consuming the advertising content may be made such that the user has to actively interact with the application. User interaction may be configured such that it generates and sends the confirmation signal to AP/charging station 102. Similarly, when the advertising content is delivered directly to client device 118 from another system (e.g., system 130, service 134, etc.), the confirmation signal may be relayed by the other system to AP/charging station 102 so that it can control delivery of the compensation in accordance with the consumption of advertising content at client device 118.

Alternatively, or additionally, a termination signal is sent when the application is closed by the user, when idling is detected, and/or when the link used to deliver the compensation/recompense is disrupted (e.g., when the wireless power transfer link or the Internet access link is disrupted, or when the link used to deliver the advertising content is disrupted). For example, in an embodiment, power transfer interfaces 126 of client device 118 alert the application when power transfer is disrupted, which triggers a termination signal to be sent to AP/charging station 102. AP/charging station 102, accordingly, causes the advertising content delivery to client device 118 to stop.

Based on the confirmation signal and/or the termination signal, AP/charging station 102 may generate, via module 202, session data that includes a measure of consumption of advertising content by client device 118. The session data may be updated continuously and saved as part of session management data 210 of storage 106. At the end of the session, AP/charging station 102 may use the session data to collect a payment from one or more sponsor(s) or provider(s) of the advertising content delivered and consumed by client device 118. For example, AP/charging station 102 may deliver advertising content from local business system 130 to client device 118. In accordance with the consumption of the advertising content by client device 118, AP/charging station 102 generates the session data and a corresponding bill for system 130. AP/charging station 102 may then send the bill to service 132 to debit an account associated with system 130. Other methods for receiving payment for delivered advertising content may be used as would be understood by a person of skill in the art based on the teachings herein.

Similarly, when consuming the advertising content by client device 118 includes payment by the user to a third-party (e.g., purchase of a product/service advertised by AP/charging station 102, redemption of advertising content (e.g., coupon, discount, etc.) delivered to client device 118 by AP/charging station 102, etc.), AP/charging station 102 may subsequently collect a payment from the third-party in return for encouraging the sale. Specifically, AP/charging station 102 may store successful transaction results in the area of storage 106 allocated for session management data 210, and may subsequently collect a payment from the third party on the basis of this session data. For example, AP/charging station 102 may deliver a coupon from local business system 130 to client device 118. AP/charging station 102 may maintain a record of the delivered coupon in session management data 210. When the user of client device 118 redeems the coupon at the local business, a transaction result is delivered to AP/charging station 102 and associated with the coupon record in the session management data 210. Subsequently, AP/charging station 102 may seek a payment from the local business for encouraging the sale.

In another embodiment, AP/charging station 102 sends the session data (e.g., successful transaction result) to a server upon a disruption of the delivery of the compensation to client device 118. For example, client device 118 may have paid to receive wireless charging from AP/charging station 102. Subsequently, client device 118 may walk away from AP/charging station 102, disrupting the wireless charging, before exhausting a wireless charging credit. To avoid client device 118 losing the credit, AP/charging station 102 sends the session data to a server where the session data is persisted. The same session data may be persisted in client device 118 such that client device 118 can continue its charging session at another station (e.g., alternate Ar′ 136).

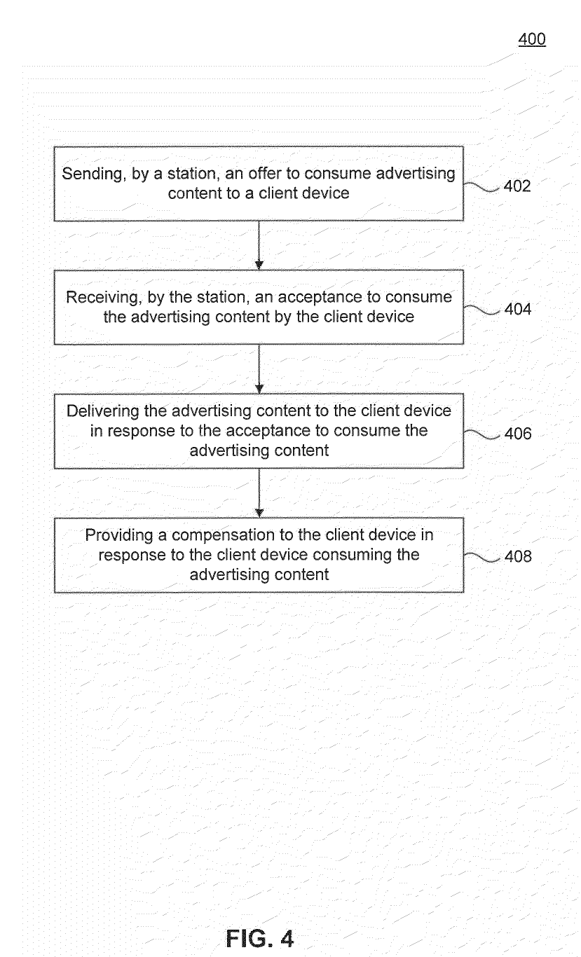

FIG. 4 is a process flowchart 400 of a method according to an embodiment of the present disclosure. Process 400 is provided for the purpose of illustration and is not limiting of embodiments of the present disclosure. Process 400 may be performed by a station such as AP/charging station 102.

As shown in FIG. 4, process 400 begins in step 402, which includes sending, by a station, an offer to consume advertising content to a client device. As described above, step 402 may be triggered upon the client device moving into a vicinity of the station, which causes a communication link to be established between the station and the client device. The offer is sent by the station to the client device over the communication link, and may include an offer to view the advertising content on a display, interact with the advertising content via a user interface, redeem the advertising content with a vendor, and/or purchase a product or service associated with the advertising content.

If the user of the client device accepts the offer, process 400 proceeds to step 404, which includes receiving, by the station, an acceptance to consume the advertising content by the client device. As described above, the acceptance to the offer may take the form of a successful payment confirmation for an advertised product/service, delivered to the station by a payment processing service. Alternatively, the acceptance may be sent from the client device to the station over the established communication link, and may include user input and/or data automatically extracted from the client device (e.g., user and/or device profile, advertisement type preference, advertisement session selection).

Upon receiving the acceptance, the station may extract, when applicable, one or more of a user profile, a device profile, an advertisement type preference, and an advertisement session selection from the acceptance. Subsequently, process 400 proceeds to step 406, which includes delivering the advertising content to the client device in response to the acceptance to consume the advertising content. Step 406 may further include tailoring the advertising content based on the user profile, device profile, advertisement type preference, or advertisement session selection. In an embodiment, the advertising content is received by the station from a server and then sent to the client device. In another embodiment, the station identifies an IP address of the client device (e.g., from the acceptance) and forwards the IP address to a server, which then uses the IP address to deliver the advertising content directly to the client device.

When the client device begins consuming or consumes the advertising content, a confirmation signal is delivered to the station by the client device and/or by another system that delivers the advertising content to the client device. Subsequently, process 400 proceeds to step 408, which includes providing a compensation to the client device in response to the client device consuming the advertising content. According to embodiments, the client device consuming the advertising content may comprise one or more of viewing the advertising content on a display; interacting with the advertising content via a user interface; redeeming the advertising content with a vendor; and purchasing a product or service associated with the advertising content.

In an embodiment, process 400 further includes the station generating session data based on the client device consuming the advertising content. The session data may be generated on the basis of the confirmation signal and/or a termination signal, which signals that the client device has stopped consuming the advertising content and/or a disruption in the delivery of the compensation to the client device (e.g., disruption of a wireless power transfer link used to wirelessly charge the client device). When the termination signal is received, the station stops delivery of the advertising content or providing the compensation to the client device. Additionally, process 400 may include collecting a payment, by the station, from a sponsor of the advertising content based on the session data.

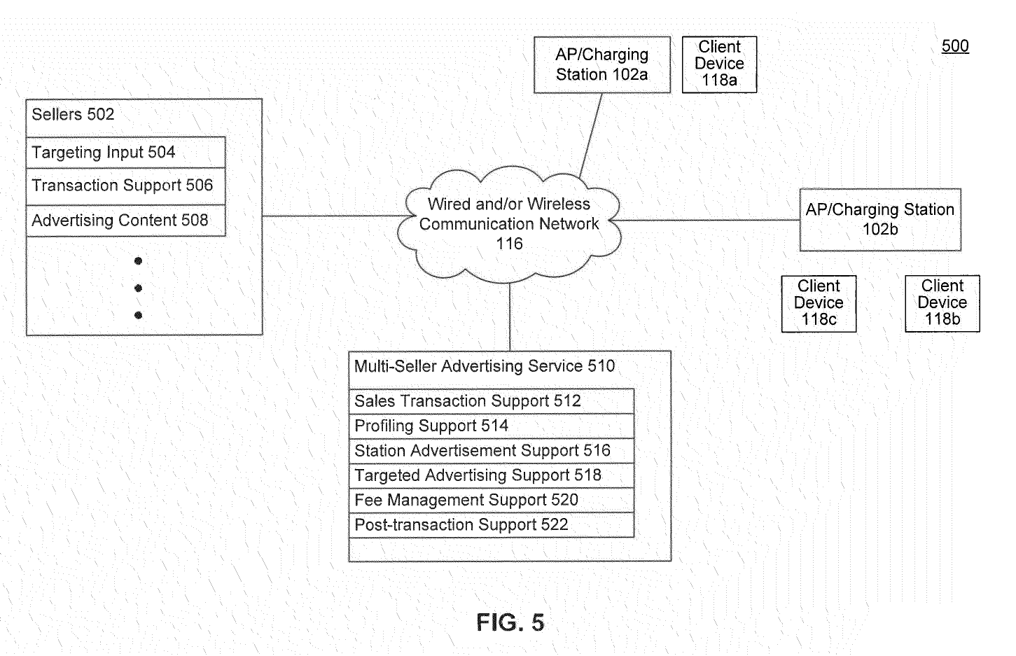

FIG. 5 illustrates an example system 500 according to an embodiment of the present disclosure. Example system 500 is provided for the purpose of illustration and is not limiting of embodiments of the present disclosure. As can be appreciated by a person of skill in the art based on the teachings herein, embodiments of the present disclosure may be used to enable different systems than shown in FIG. 5.

As shown in FIG. 5, example system 500 includes sellers 502, a multi-seller advertising service 510, a plurality of AP/charging stations 102a-b, and a plurality of client devices 118a-c. A wired and/or wireless communication network 116 (e.g., the Internet, a cellular network, etc.) connects the various components of example system 500. The various components of example system 500 may be located in various geographical locations, which may be near or remote from each other.

AP/charging stations 102a-b may be as described above with reference to FIGS. 1 and 2. AP/charging stations 102a-b may be located within the same geographical environment (e.g., shopping mall, airport, etc.) or in different remote environments. AP/charging stations 102a-b may be managed by the same entity' and thus may communicate with each other via network 116, for example. For example. AP/charging stations 102a-b may be managed by the same entity as service 510. Alternatively, AP/charging stations 102a-b may be managed by an entity other than the one managing service 510, and may thus receive compensation from the entity managing service 510. Client devices 118a-c may be as described above with reference to FIGS. 1 and 3.

Sellers 502 includes a plurality of sellers interested in targeting users in example system 500. Sellers 502 may include physical (brick and mortar) stores or online retailers. Through a portal, system 500 enables each seller to specify targeting input 504. Targeting input 504 may include any type of input that can be used by a seller to target specific user groups. For example, targeting input 504 may include geographical location, age, gender, education level, device type, etc.

Each seller may also have access to transaction support 506. Transaction support 506 enables the seller to perform transactions with clients, such as client devices 118a-c. Transaction support 506 may enable the exchange of various types of information between a seller and a client device, including client information, product/service information, payment information, promotional codes, rebates, and payment verifications, for example.

Additionally, each seller can provide advertising content 508. Advertising content 508 may include any type of content (e.g., text, audio, video, animation, etc.) intended to drive consumer behavior and/or encourage or persuade an audience to take some action. For example, advertising content 508 may include one or more of a product advertisement, a service advertisement, a consumer survey, etc. Advertising content 508 ma be entered in a specified format by the seller.

Multi-seller advertising service 510 may run on one or more servers, and may include sales transaction support 512, profiling support 514, station advertisement support 516, targeted advertising support 518, fee management support 520, and post-transaction support 522.

In an embodiment, service 510 uses station advertisement support 516 to advertise available AP/charging stations to client devices. For example, upon entering a certain environment, client device 118a may share its geographical location with service 510. Service 510 may in return provide a map that shows nearby AP/charging stations and/or directions to the nearest AP/charging station 102a.

Profiling support 514 enables the support of user/device profiles by service 510. Profiles may be created on-demand or pre-stored within the client device or service 510. For example, a user may create a profile on-demand by answering a series of questions or selecting a number of preferences. The user may also share its geographical location with service 514 as part of its profile. Other profile aspects may be automatically extracted by service 510 from the device, including device properties and capabilities. The user may select to store the profile with service 514 or on the device for future use.

Targeted advertising support 518 enables targeted advertising to client devices 118 using advertising content 508 provided by sellers 502. Specifically, for each seller, targeted advertising support 518 works in conjunction with profiling support 514 to deliver advertising content 508 to appropriate user groups based on targeting input 504 of the seller. Specifically, targeted advertising support 518 matches targeting input 504 to profiles supported by profiling support 514, and delivers advertising content 508 to client devices associated with the identified profiles. In an embodiment, the delivery of targeted advertising may be following an acceptance to consume advertising content by the client device in return for wireless charging by an AP/charging station 102. Alternatively, or additionally, the advertising may be pushed to the device while operating a browser or other application.

Sales transaction support 512 may be similar to transaction support 506 described above and may support transactions between client devices 118 and service 510 (e.g., to purchase services such as wireless charging/Internet access via AP/charging stations 102). Additionally, sales transaction support 512 may support sales transactions on behalf of sellers 502. For example, a user of client device 118a may select to make a purchase based on targeted advertising content delivered by service 510. The purchase may be effectuated either via service 510 or by connecting directly to the particular seller. When the purchase is performed via service 510, transaction support 512 acts as an intermediary between the seller and the client device, delivering all the necessary transaction information to the seller and/or the client device. For example, transaction support 512 may convey payment and product information to the seller and a confirmation code to the device when the transaction is successful. Transaction support 512 may also deliver to the client device directions to the seller's physical store in order to pick up the purchased item.

Transaction support 512 may also store transaction details and may subsequently use the transaction details to get compensated by the seller (e.g., a percentage of the transaction amount) for encouraging the sale. Accordingly, sales transaction support 512 may have the ability to track a sales transaction performed directly between the client device and the seller and to log the transaction details for subsequent compensation by the seller.

Fee management support 520 enables service 520 to track fees paid and credits associated with client devices 118 for services provided by AP/charging station 102. In an embodiment, fee management support 520 maintains credit accounts for client devices 118. Using this information, service 520 may control the delivery of services by AP/charging stations 102 to client devices 118. In an embodiment, credit for a client device 118 may accrue as a result of consuming advertising content. Credit may be used in return for services (e.g., wireless power charging, Internet access, etc.) at the same time as advertising content is being consumed or at another time in the future. In another embodiment, credit may accrue after completing a sales transaction with service 510 or with a seller.

Post-transaction support 522 allows for persistence of session information after termination of a session between a client device 118 and an AP/charging station 102. In an embodiment, a client device may be given free service credit in return for a promise to perform a sales transaction within a defined time in the future. The credit account associated with the device as well as the promise are persisted by post-transaction support 522. The credit account of the device is then debited only if the device does not make the purchase as promised. In a farther embodiment, a client device may purchase a service (e.g., wireless power charging), then at a later time may redeem advertising content (e.g., coupon) delivered while receiving the service. This information is persisted by post-transaction support 522 allowing the client device to receive a portion of its initial payment back. In a further embodiment, a client device may opt to receive a payment back in return for any unused purchased credit upon termination of a session with an AP/charging station 118.

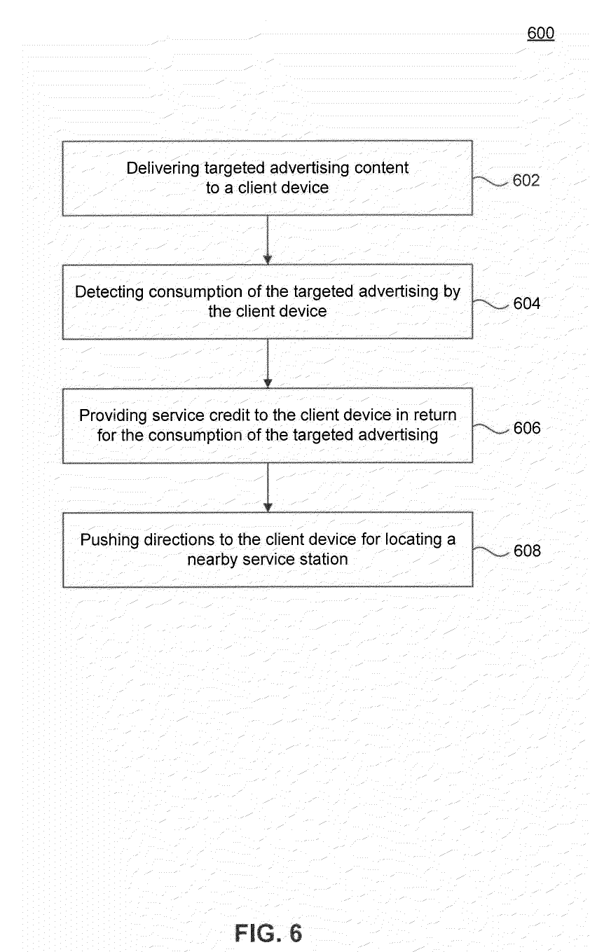

FIG. 6 is a process flowchart of a method according to an embodiment of the present disclosure. Process 600 is provided for the purpose of illustration and is not limiting of embodiments of the present disclosure. Process 600 may be performed by a multi-seller advertising service such as service 510 described above in FIG. 5.

As shown in FIG. 6, process 600 begins in step 602, which includes delivering targeted advertising content to a client device. In an embodiment, step 602 may be in response to an acceptance to consume advertising content received from the client device by service 510 as described above. Alternatively or additionally, the advertising content may be pushed to the client device, either separately or with other content being consumed by the client device.

Step 604 includes detecting consumption of the targeted advertising by the client device. As described above, consuming advertising content includes one or more of viewing the advertising content on a display, interacting with the advertising content via a user interface, redeeming the advertising content with a vendor, and purchasing a product or service associated with the advertising content. According to embodiments, as described above, user activity can be tracked to determine whether the client device is consuming or has consumed delivered advertising content.

Subsequently, if consumption of the advertising content is detected, process 600 proceeds to step 606, which includes providing service credit to the client device in return for the consumption of the targeted advertising. For example, as described above, a credit account associated with the client device may be credited in return for the client device purchasing an advertised product. Alternatively, the service credit may be replaced with returning a portion of a payment previously made by the client device to purchase a particular provided service (e.g., wireless charging, Internet access, etc.).

Finally, process 600 may optionally include pushing directions to the client device for locating a nearby service station. For example, if in step 606, the client device is provided wireless power transfer credit, directions (e.g., map) to a nearby wireless power transfer station are provided for helping the client device locate the station.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present disclosure should not be limited by any of the above-described exemplary embodiments, but should be defined only in accordance with the following claims and their equivalents.

What is claimed is:

1. A wireless power transfer (WPT) charging station, comprising:
a wireless communication interface configured to transmit targeted advertising content to a client device in response to an acceptance to consume advertising content by the client device, wherein the targeted advertising uses at least one of a geographical location, a user profile, and a device profile associated with the client device; and
a WPT interface configured to transfer wireless power to the client device in response to the client device consuming the targeted advertising content.

2. The WPT charging station of claim 1, further comprising:
a first nodule configured to extract information from the acceptance to consume the targeted advertising content, wherein the extracted information includes one or more of the user profile, the device profile, an advertisement type preference selected by the client device, and an advertisement session selection selected by the client device; and
a second module configured to send the extracted information to a server and to receive the targeted advertising content from the server.

3. The WPT charging station of claim 1, farther comprising:
a first module configured to extract information from the acceptance to consume the targeted advertising content from the client device;
a storage; and
a second module configured to retrieve the targeted advertising content from the storage based on the extracted information.

4. The WPT charging station of claim 1, further comprising:
a first module configured to generate session data based on the client device consuming the targeted advertising content and to collect a payment from a sponsor of the targeted advertising content based on the session data.

5. A method, comprising:
sending, by a station, an offer to consume advertising content to a client device;
receiving, by the station, an acceptance to consume the advertising content by the client device;
delivering the advertising content to the client device in response to the acceptance to consume the advertising content; and
providing a compensation to the client device in response to the client device consuming the advertising content.

6. The method of claim 5, wherein the advertising content includes one or more of a product advertisement, a service advertisement, and a survey.

7. The method of claim 5, wherein the compensation includes one or more of Internet access, charging power, a product discount, and a service discount.

8. The method of claim 5, wherein delivering the advertising content to the client device comprises:
receiving, by the station, the advertising content from a server; and
sending the advertising content from the station to the client device.

9. The method of claim 5, wherein delivering the advertising content to the client device comprises:
identifying, by the station, an Internet Protocol (IP) address of the client device; and
forwarding the IP address of the client device from the station to a server,
wherein the advertising content is delivered to the client device from the server.

10. The method of claim 5, further comprising:
receiving, by the station, a termination signal; and
stopping delivery of the advertising content or providing the compensation to the client device in response to the termination signal.

11. The method of claim 10, wherein the termination signal is in response to the client device stopping to consume the advertising content or a disruption of a wireless power transfer link between the station and the client device.

12. The method of claim 5, further comprising:
extracting information from the acceptance to consume the advertising content, wherein the extracted information includes one or more of a user profile, a device profile, an advertisement type preference, and an advertisement session selection; and
tailoring the advertising content based on the extracted information.

13. The method of claim 5, further comprising:
generating session data based on the client device consuming the advertising content; and
collecting a payment from a sponsor of the advertising content based on the session data

14. The method of claim 5, further comprising:
generating session data based on the client device consuming the advertising content; and
sending the session data to a server upon a disruption of a wireless power transfer link between the station and the client device.

15. A device, comprising:
a user interface operable by a user to respond to an offer to consume advertising content from a station;
a communication interface configured to receive the advertising content upon acceptance by the user to consume the advertising content; and
processing circuitry configured to process the advertising content to enable the user to consume the advertising content using the user interface, and further configured to send a confirmation signal to the station in response to the user consuming the advertising content.

16. The device of claim 15, further comprising:
a power transfer interface configured to receive charging power from the station, wherein the charging power is delivered by the station in response to the confirmation signal.

17. The device of claim 15, wherein the user interface includes one or more of an application program, a keyboard, a touch screen, a display, a microphone, and a camera.

18. The device of claim 15, wherein the processing circuitry is further configured to generate and send a profile to the station upon acceptance by the user to consume the advertising content.

19. The device of claim 18, wherein the profile includes one or more of a user profile, a device profile, an advertisement type preference, and an advertisement session selection.

20. The device of claim 15, wherein the processing circuitry is configured to process the advertising content to enable the user to perform one or more of:
viewing the advertising content on a display;
interacting with the advertising content via the user interface;
redeeming the advertising content with a vendor; and
purchasing a product or service associated with the advertising content.
